(19) United States
(12) Patent Application Publication
(10) Pub. No.: US 2021/0237386 A1
(43) Pub. Date: Aug. 5, 2021

(54) FLIPSIDE READER FOR SHEET PROCESSING SYSTEMS

(71) Applicant: Esko-Graphics Kongsberg AS, Kongsberg (NO)

(72) Inventors: Lars-Ole Aamodt, Kongsberg (NO); Lidvar Budal, Hønefoss (NO); Henning Hansen, Kongsberg (NO); Ivar Holm, Hokksund (NO); Thomas Malme, Kongsberg (NO); David Eirik Taylor, Kongsberg (NO); Satish Doraiswamy Naidu, Kongsberg (NO); Stian Johnsen, Kongsberg (NO)

(73) Assignee: Esko-Graphics Kongsberg AS, Kongsberg (NO)

(21) Appl. No.: 17/049,984

(22) PCT Filed: Apr. 15, 2019
(86) PCT No.: PCT/EP2019/059658

§ 371 Date: Oct. 23, 2020

Related U.S. Application Data
(60) Provisional application No. 62/662,998, filed on Apr. 26, 2018.
(60) Provisional application No. 62/753,524, filed on Oct. 31, 2018.

(51) Int. Cl. B31B 50/20; B31B 50/00; B31B 50/25; B31B 50/26

(52) U.S. Cl. CPC B31B 50/20; B31B 50/262; B31B 50/25; B31B 50/006

(57) ABSTRACT

Systems and methods for processing a sheet having a printed underside. A gap between a feeder and a processing machine provides visibility to the printed underside, cameras capture images of the printed graphics through the gap, and a processor stitches the captured images together into a continuous image of the printed underside, including registration marks, corners or edges, and a sheet identifier. Processing instructions are retrieved from storage using the detected sheet identifier and are executed along processing paths calculated from detected information regarding locations of the registration marks and the corners or edges. A material guide positioned above the material path may be configured to constrain the sheet vertically as it passes over the gap and to reduce overhead light from interfering with the image capture.

### CROSS-REFERENCE TO RELATED APPLICATIONS

This application is a National Phase of PCT Application Ser. No. PCT/EP2019/059658, filed Apr. 15, 2019, which claims priority to U.S. Provisional Application Ser. No. 62/662,998, filed Apr. 26, 2018, and to U.S. Provisional Application Ser. No. 62/753,524, filed Oct. 31, 2018, all titled the same as the present application, and all of the foregoing incorporated herein by reference in their entireties.

### BACKGROUND OF THE INVENTION

Many sheets used in, for example, the packaging industry, such as corrugated cardboard, need to be creased on the back side of the printed sheet in order to fold the correct way. Because the crease tools are suspended above the sheet, the print side of the sheet often faces downwards. A camera mounted above the sheet thus cannot read registration marks through the sheet, and the sheet typically or preferably only has printed marks on the underside of the sheet.

### SUMMARY

One aspect of the invention comprises a method for processing a printed sheet, where the print side of the sheet faces downwards. The method comprises the steps of capturing a plurality of images from the underside of the sheet, each image representative of a portion of the printed sheet within a field of view of one of the plurality of cameras, and then stitching together the plurality of images to produce a continuous image of the underside of the sheet. The continuous image includes one or more registration marks, at least one identification mark, and one or more corners of the printed sheet. The printed sheet or a job associated with the printed sheet is identified based upon detection of at least one identifying indicia on the printed sheet, from which a set of stored processing instructions associated with the detected indicia are retrieved. Locations of one or more corners of the printed sheet and locations of one or more registration marks relative to the one or more corners in table coordinates are determined from the continuous image. Actual locations of the corners of the sheet in coordinates of a processing machine are determined, from which actual locations of the registration marks in coordinates of the processing machine are determined from the foregoing steps. At least one processing path of the processing machine, such as but not limited to a creasing, cutting, or perforating path, is controlled based upon the locations of the registration marks in processing machine coordinates and the retrieved processing instructions.

The step of determining the actual locations of the corners of the sheet in coordinates of the processing machine may comprise capturing an image of a unprinted top side of the sheet and correlating the captured topside image with the continuous image of the printed underside of the sheet. The step of identifying the printed sheet or job associated with the printed sheet may comprise capturing an image of a 2D code printed on the underside of the sheet, processing the image of the code to read the code, and using the code to identify the printed sheet or the job associated with the printed sheet. The code may have machine-readable job information embedded in the code and/or the code may have embedded information that identifies a storage location in computer storage where the job information can be retrieved.

Another aspect of the invention comprises a system, or components thereof, for processing a printed sheet having at least one sheet identifier and one or more printed registration marks located on an underside of the sheet. The system comprises a processing machine for processing the sheet from a top side of the sheet, a feeder for feeding the sheet to the processing machine along a feed path that comprises a gap between the feeder and the processing machine through which the underside of the sheet is visible, and a plurality of underside cameras positioned below the gap. The plurality of underside cameras are configured to collectively capture a plurality of images. Each camera is configured to capture one or more images from the underside of the sheet as it passes over the gap along the feed path, each of the one or more images representative of a portion of the printed underside of a sheet within a field of view of one of the plurality of cameras. The system further comprises a detector configured to detect the at least one sheet identifier, at least one topside camera configured to capture an image of a top side of the sheet, including one or more corners or edges of the sheet, and a processor. The processor is configured to stitch together the plurality of images captured by the plurality of underside cameras to produce a continuous image of the printed underside of the sheet, including the one or more printed registration marks and the underside of the one or more corners or edges captured by the topside camera. The process is further configured to identify the printed sheet, or a job associated with the printed sheet, based upon the detected sheet identifier(s), and retrieve stored processing instructions associated with the printed sheet or the job. The processor is also configured to determine in table coordinates the locations of the one or more corners of the printed sheet and locations of the one or more registration marks relative to the one or more corners; and calculate at least one path for processing the printed sheet based on the locations of the registration marks relative to the one or more corners and the processing instructions. A controller in the processing machine in communication with the processor is configured to execute the processing instructions.

The at least one sheet identifier may comprise a printed 2D code and the detector may comprise a camera positioned to capture an image of the printed 2D code. The camera positioned to capture the image of the 2D code may be one of the plurality of underside cameras, or the plurality of underside cameras may comprise a first set of at least two cameras configured to capture the image of the one or more printed registration marks and the underside of the one or more corners or edges, and at least one dedicated camera configured to capture the image of the 2D code, wherein the at least one dedicated camera is not in the first set of at least two cameras. The code comprises machine-readable job information embedded in the code and/or the code comprises embedded information that identifies a storage location in computer memory where the job information can be retrieved, in which case the system also comprises the computer memory accessible to the processor. The processing machine may be a finisher configured to create creases, cuts, or perforations in the sheet.

In some systems, a material guide positioned above the material path may be configured to constrain the sheet vertically as it passes over the gap and/or to reduce light emanating from above the material guide from impinging upon the detector. The material guide may have a leading edge that is disposed and configured to gradually urge a vertically raised edge of the sheet in a downward direction as the sheet moves relative to the guide along the material path. An extension may be disposed on a trailing edge of the material guide and disposed parallel to the material path. The material guide may be removable and vertically adjustable relative to the material path.

Another aspect of the invention comprises a system for processing a printed sheet having one or more machine-detectible features located on an underside of the sheet. The system comprises a processing machine for processing the sheet and a feeder for feeding the sheet to the processing machine along a material path, the material path comprising a gap between the feeder and the processing machine through which the underside of the sheet is visible. One or more detectors, including at least one image capture device, is positioned underneath the feed path configured to detect the machine-detectible features as the sheet passes through the gap, and a material guide is positioned above the feed path and configured to constrain the sheet vertically as it passes through the gap.

Yet another aspect of the invention comprises a computer-implemented method for processing a printed sheet. The computer-implemented method comprises the step of capturing, by a plurality of cameras positioned below a gap between a feeder and a processing table traversed by the printed sheet as it moves from the feeder to the processing table, a plurality of images, each image representative of a portion of a printed underside of a sheet within a field of view of one of the plurality of cameras. The method further comprises stitching together, by a computer processor, the plurality of images to produce a continuous image of the printed underside of the sheet, including one or more registration marks, at least one identification mark, and one or more corners or edges of the printed sheet. The computer processor identifies the printed sheet or a job associated with the printed sheet based upon detection of identifying indicia on the sheet, and determines processing instructions associated with the identifying indicia. The computer processor also determines actual locations of the corner(s) of the printed sheet in machine coordinates. The computer processor then determines locations of the registration mark(s) in machine coordinates based upon the actual locations of the corner(s) in machine coordinates and the locations of the registration mark(s) relative to the corner(s). The computer processor controls at least one path for processing the printed sheet based upon the locations of the registration marks in machine coordinates and the processing instructions.

### BRIEF DESCRIPTION OF THE DRAWINGS

FIG. 1 is a schematic top plan view of an exemplary flipside reader system as described herein.

FIG. 2 is a photograph of an underside of the gap between a feeder and a processing table, showing an exemplary reference sheet for calibrating the camera system.

FIG. 3A is a photograph of an underside of an exemplary sheet to be processed.

FIG. 3B is a print out of an image of the sheet of FIG. 3A as captured by an exemplary system as described herein.

FIG. 4 is a schematic side view drawing depicting a line of processing machines, including a feeder, the camera systems described herein, and a finishing machine.

FIG. 5 is a schematic diagram depicting an exemplary processing system and connected sensors and controllers.

FIG. 6 is a flowchart depicting an exemplary process embodiment of the invention.

FIG. 7A is a schematic side view of a portion of an exemplary flipside reader system, illustrating a warping problem that may occur with certain types of sheet media.

FIG. 7B is a portion of an exemplary image of a sheet captured by an exemplary flipside reader system, illustrating image distortion due to warping.

FIG. 7C is an exemplary image of a sheet captured by an exemplary flipside reader system, illustrating the impact of external light on the image.

FIG. 8A is a schematic side view of a portion of an exemplary flipside reader system featuring an exemplary material guide mounted above the gap.

FIGS. 8B-8D illustrate a sheet in various stages of transport relative to the exemplary material guide of FIG. 8A.

FIG. 9A illustrates an exemplary system for providing an adjustable material guide.

FIG. 9B illustrates a cross-section of the exemplary material guide of FIG. 9A.

FIG. 9C illustrates a cross-sectional view of the material guide of FIG. 9A in a relatively low position.

FIG. 9D illustrates a cross-sectional view of material guide of FIG. 9A in a relatively high position.

### DETAILED DESCRIPTION OF THE INVENTION

In one aspect of the invention, an underside camera system scans from below the printed side of a sheet to be processed. Specifically, one or more cameras are positioned transversely along a gap between a feeder and a processing table, such as a creasing and/or cutting table, to scan for registration marks. A dedicated detection device, such as a camera, may be located adjacent to a known sheet identification zone to scan for 2D codes, such as QR, Data matrix, Code39 or similar visual codes, or other indicia, to identify the sheet or other attributes relating to the sheet. The code may contain more information than just an identification of the sheet, including the cut path information or a link to such information. The indicia is not limited to printed 2D codes. For example, the code, indicia, and readers therefor may conform to any of the embodiments disclosed in U.S. Provisional Application Ser. No. 62/653,972, titled “METHOD FOR PERSISTENT MARKING OF FLEXO PLATES WITH WORKFLOW INFORMATION AND PLATES MARKED THEREWITH,” incorporated herein by reference.

The detection system, including the cameras and indicia reader, locates the registration marks, the sheet-identifying indicia, and the corners or edges of the sheet, and then calculates an actual cut/crease path in table coordinates based on where the sheet registration marks are actually located in machine coordinates. The actual cut/crease path is based upon a pre-existing set of cut/crease path instructions relating to the sheet, which instructions may be based upon the information used for printing the image, including the registration marks, on the sheet. The 2D code may provide identifying information that enables retrieval from computer storage of stored information for processing the sheet, such as the pre-existing set of cut/crease path instructions. As is known in the art, the actual location of the registration marks may not be precisely where predicted, due to distortions introduced at one of any of the process steps between creation of the image and feeding of the printed substrate for cutting and/or creasing, and therefore the processor for converting the stored instructions into actual instructions for the machine may take into account information based upon sensed locations of the actual registration marks, such as with a topside camera.

The captured images from the underside cameras are stitched together to form a complete image of the sheet printed graphics including all of the registration marks relative to the corners of the sheet. The stitching operation may be facilitated by initially calibrating the individual cameras against a reference object. Essentially, in one embodiment, the system identifies printed registration marks and barcodes on the underside of the sheets in order to crease and cut the sheets properly without disturbing the registration marks and barcodes.

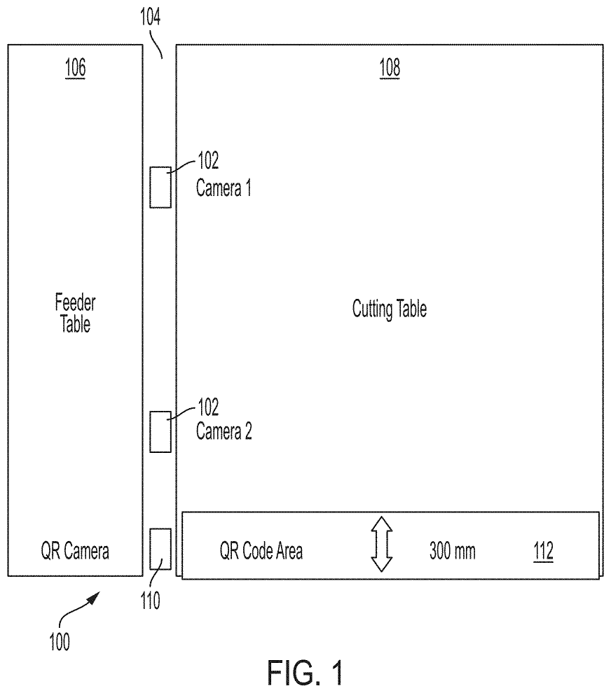

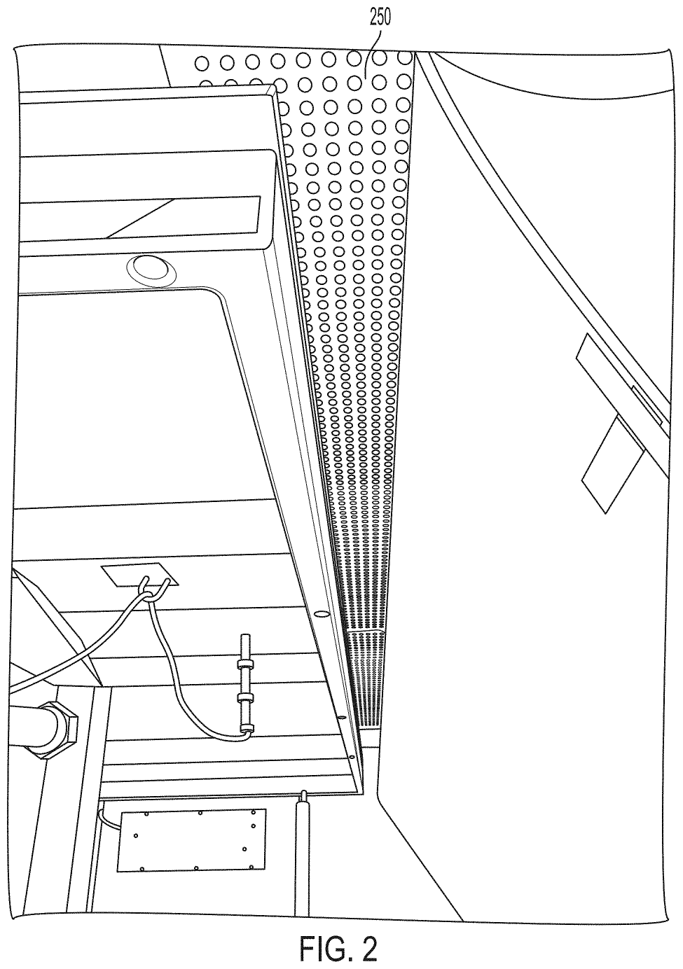

Referring now to the FIGS. 1 and 2, preferred embodiments include a plurality of stationary overlapping cameras 102 (Camera 1 and Camera 2). To compensate for print distortion and position, cameras 102 may be calibrated against a common reference object 250, such as a sheet with a regular pattern of geometric shapes (such as but not limited to black circles or holes as depicted in FIG. 2). The cameras 102 together cover the entire gap (field of view) 104. One camera 110 may be dedicated to reading identifying indicia, such as bar codes, while the other cameras may be dedicated for registration mark reading, or camera 110 may be configured to read both identifying indicia and registration marks. A plurality of cameras, each with a relatively narrow field of view, is preferred for imaging the printed sheet, to minimize distortions otherwise caused by relatively large angles between the camera and the edges of a relatively wider field of view. The invention is not limited to any particular number of cameras, however. For some types of processes and sheets, a single camera may suffice for detection of the registration marks. In most systems, however, multiple cameras are preferred.

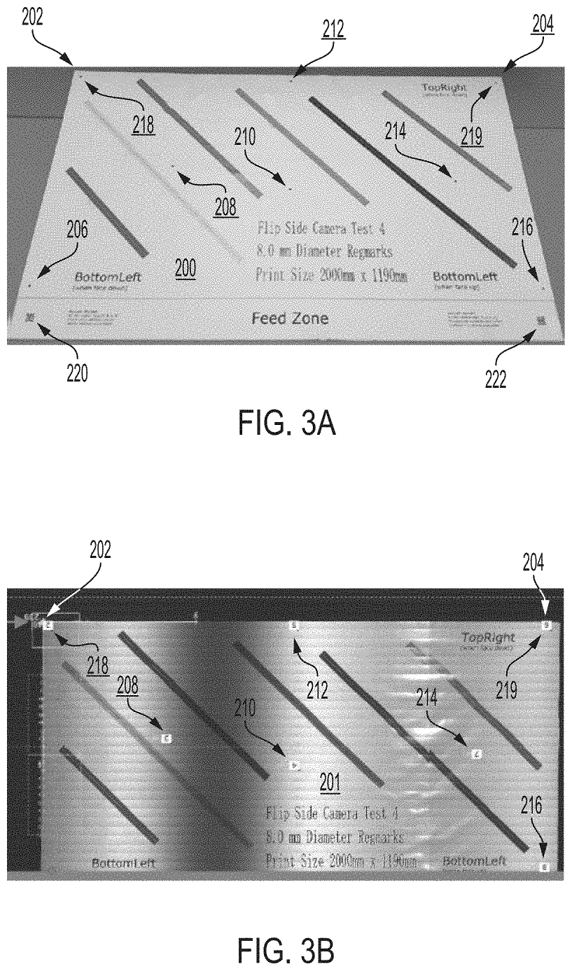

Reading/scanning of the sheet, such as sheet 200 depicted in FIG. 3A, is preferably performed at full loading speed from feeder table 106 to cutting table 108, which may be, for example, a Kongsberg table made by Esko Graphics Kongsberg AS of Norway. The feeder may comprise a conveyor belt, and may receive a sheet loaded onto the sheet feeder from a stack of sheets ready for processing, as is known in the art. Features (e.g. sheet corners 202, 204; registration marks 206, 208, 210, 212, 214, 216, 218, 219; and codes 220, 222) are captured and recognized by a machine vision system comprising cameras 102 and 110, while sheet feeds over the gap 104. Software capable of processing captured images to recognize registration marks, 2D printed codes, and corners is well known in the art.

The images captured from the underside of the sheet by the individual cameras 102 are stitched together by a processor into a continuous image that gives a complete image of the sheet graphics and its features, such as the image depicted in FIG. 3B. Software capable of processing captured images to stitch them together is also well known in the art, such as is available from Tordivel AS, of Oslo, Norway. It is desirable to maintain the distance from the camera to the sheet constant to maximize accuracy. Otherwise, a “wavy” sheet, or a leading or trailing edge of a sheet that dips or lifts slightly when pulled over the gap (104) may cause undesired inaccuracy. The machine vision system of the cameras and processors and/or the sheet feeding system may have provisions to compensate for this potential problem, which may be more likely with certain types of substrate materials and/or substrate sizes than others. The location of the registration marks relative to the corners in sheet coordinates may be determined by analysis of the continuous image or by analysis of the individual images before being stitched together into the continuous image.

An image of the 2D identifying code (e.g. a QR code, data matrix code, code 39 barcode, etc., as are well known in the art) is captured by camera 110, which is preferably configured to capture images in a dedicated zone to automatically identify the job. In some embodiments, camera 110 is a dedicated camera just for detecting identifying codes, and different cameras 102 are configured to detect the image that is stitched together featuring the registration marks. In other embodiments, camera 110 may also contribute to the images stitched together to form the continuous image. By providing the ability to identify a sheet or at least a job associated with a sheet, the in-stack of sheets to be processed may contain a random assortment of jobs so long as each sheet has a recognized code in a recognized format in the designated zone. While it is preferred for the code to be located in a dedicated zone by a dedicated camera, in some embodiments, the code may be located anywhere on the sheet, and the camera and related processing software may be capable of locating the code anywhere in the image and accessing the reading the information associated with the code.

The creasing/cutting table may be configured to compensate for cut path distortion based upon the actual location of the register marks. The actual sheet position and locations of the relevant features are determined by taking the image captured from the underside of the substrate and correlate it to an image captured by a topside/above-mounted camera that recognizes the actual locations of the corners or edges of the sheet. The cut/creasing path instructions are then calculated relative to the actual location of the substrate as adjusted for any distortion present in the printed image on the substrate.

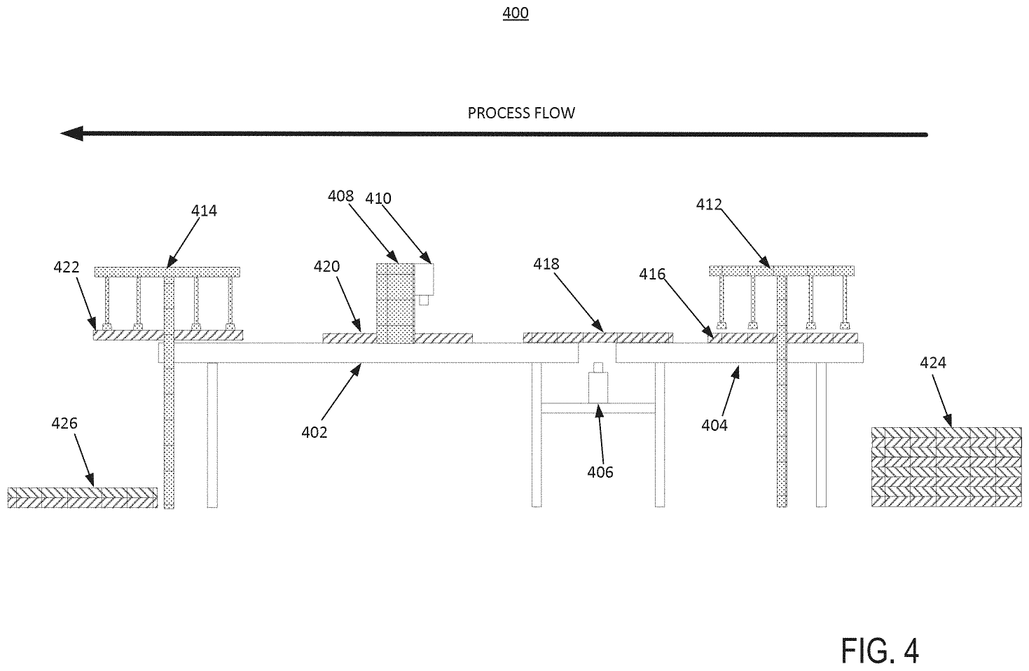

As depicted in FIG. 4, sheets are advanced right-to-left along the “process flow” arrow in system 400. Sheets 416, 418, 420, 422 are shown in various positions for ease of illustration, but it should be understood that in many embodiments, only a single sheet may be in process at a time, and thus 416, 418, 420, 422 may represent different positions of a single sheet in process. Other embodiments, however, may have a suitable machine layout to permit multiple sheets to be in various stages of process at the same time, for example by having multiple small conveyor belts that can move one sheet off of the processing table, while another sheet remains stationary for processing. In still other embodiments, the converting system may comprise a number of separate modules specialized for a particular operation (e.g. a crease module and a cut module with a feeder between them), in which case multiple sheets (one in process in each module) may be in process simultaneously. From right to left, sheet in position 416 on feeding table 404 may be pulled from a first stack 424, such as from a pallet, by a first robotic sheet handler 412. The feeding table 404 then passes the sheet, shown in position 418, over flipside camera system 406 to capture the underside image using a plurality of cameras, as described herein, as it moves to finishing table 402. As described herein, the image capture by system 406 may include capturing identifying indicia about the sheet or a job associated with the sheet, such as via a printed 2D code. In position 420, the sheet is then scanned by an overhead or topside camera 410 associated with the finishing table, such as mounted on gantry system 408. The topside camera 410 may traverse the X-Y dimensions of the sheet using the gantry system in search of the locations of the corners or edges of the sheet, which may include using information about the sheet or the job to give the gantry system approximate expected locations of the corners or edges for efficient scanning.

Once the overhead camera determines the actual location of at least one corner (or actual locations of two or more corners of the sheet, depending upon the capabilities of the system) in table coordinates, that corner or those corners are then used as a reference point or points for the information gleaned from the images captured by camera system 406 and/or the continuous image stitched together therefrom. While some systems may be capable of determining the position of the sheet using only one corner, and others may require multiple corners, the invention is not limited to practice on any particular system. In a machine or system capable of reliably placing the sheet so accurately on the table that the position can be reliably assumed without locating one or more corners, an overhead camera may not be required at all to perform the step of determining the actual position of the sheet on the table. Thus, the locations of the registration marks relative to the corners in sheet coordinates are then translated to machine coordinates, and the job information is applied to the machine coordinate information based upon the actual locations of the marks. The finishing machine then applies cuts, creases, perforations, and the like, in accordance with stored instructions, typically using the same gantry system 408 and one or more tools attached thereto. The processing instructions may be pre-programmed for a set of like jobs, or may be indexed to the identity of the sheet as identified by identifying indicia, or may be stored in the indicia. After finishing, the sheet is then moved off of the finishing table for further processing, such as for handling by a second robotic sheet handler 414 in sheet position 422, or by a human operator, for placement on an out-stack 426, such as a second pallet. Although shown with a robotic sheet handlers 410, 414 on the front and back ends, it should be understood that a human operator may be used in one or both positions. Also, although shown as moving from a first to a second stack, one or both of the steps preceding the feeding and finishing tables may comprise other process steps.

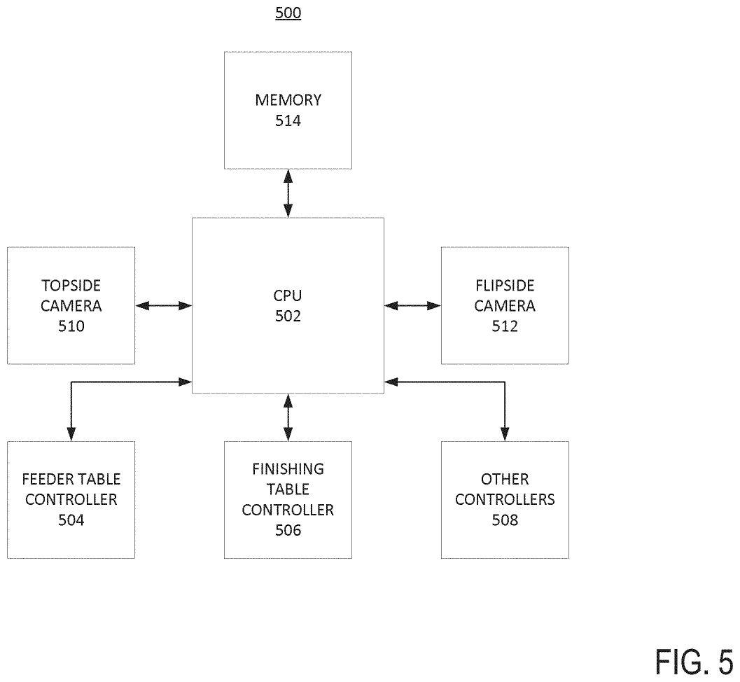

As depicted in FIG. 5, system 500 as described herein may include a processor, such as a central processing unit (CPU) 502 connected to a computer memory 514, to the flipside camera system 512, to the top side camera 510, and to the respective controllers for the feeder table 504, finishing table 506, and, optionally, controllers 508 for any other machines (such as robots for moving the sheets to and from respective in- and out-stacks). The processor is programmed with instructions for receiving digital images from the plurality of cameras of flipside camera system 512, and for stitching the images together to form the continuous image corresponding to the printed side of the sheet. The processor is also configured to identify the sheet or a job associated with the sheet from indicia on the sheet, such as from an image of a printed code captured by a camera in camera system 512 positioned to read the code. The identification may include interpreting coded data embedded in the code to read a unique identifier for the sheet or for a job associated with the sheet, and using the unique identifier to retrieve stored processing instructions. The invention is not limited to the type of indicia, type of reader for the indicia, or information stored in the indicia, however, as noted above. The processing instructions are then sent to the finishing table controller 506 for instructing the finishing table to apply cuts, creases, perforations, and the like to the sheet in accordance with the instructions. The processor 502 is also configured to coordinate the controllers of the feeder table and processing table conveyance systems for coordinating the passage of the sheet from one to the other at a desired speed, and activating the flipside camera system in accordance therewith, to capture the images as the sheet is passed.

Thus, a general process for using the system as described herein, includes in step 602 capturing images through a gap between a first machine (feeder table) and a second machine (processing table) of the printed side (underside) of sheet as it moves from the first to second machine. In step 604, the captured images are stitched together to produce a continuous image. In step 606, which may be performed simultaneously with step 602, identifying indicia for the sheet is detected, such as but not limited to, capturing a 2D code using a dedicated camera or other type of machine vision system in the flipside camera system. In step 608, the job associated with the identifying indicia is determined, such as but not limited to by retrieving or interpreting stored instructions associated with the identifying indicia. In step 610, the continuous image is processed to determine the corners of the printed sheet and location of registration marks in the continuous image relative to the corners. In step 612, the actual location of the corners of the sheet are determined in processing table coordinates, such as by using machine vision to locate the corners, such as with a camera mounted to the processing table gantry system. Then, in step 614, the location of registration marks is translated to processing table coordinates using the actual corner locations and locations of the registration marks relative to the corners as determined in step 610. Finally, the printed sheet is processed by the processing table in step 616, such as by applying cuts, creases, perforations, and the like in accordance with the job instructions determined in step 608.

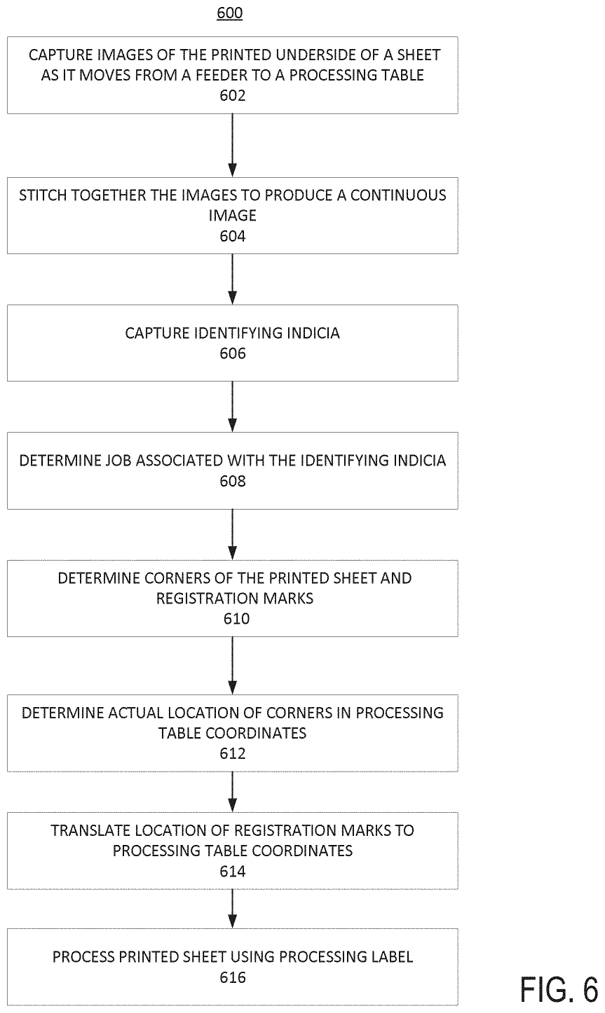

It should be understood that although the flowchart depicted in FIG. 6 is sequential in nature, the invention is not limited to any particular sequence of steps, and some steps may occur simultaneously. For example, capture of the flipside images and reading the identifying indicia in steps 602 and 606 may happen simultaneously or in any order, after which the stitching 604 may be performed at any time after image capture and the job determination step 608 may be performed at any time after detection of the identifying indicia. Determination of the registration marks relative to the sensed corners or edges of the printed sheet in step 610 may occur at any time after the stitching step 604, but not necessarily before or after steps 606 and 608. While ideally, the step 612 of determining the actual locations of the corners of the sheet in machine coordinates may occur after step 608 of determining the job associated with the sheet (because such information may provide for efficient searching for the corners), this may not be critical in some systems. For example, in systems in which the sheet size is constant or known, or in systems that have other systems and methods for effecting efficient searching, sheet or job specific information may not be needed before commencing the search for the corners. Corner location may also be derived by capturing two intersecting sheet edges, which enables calculation of the position of the corner of a sheet by assuming straight edges. The print location may be given relative to a corner and an orientation of the sheet, and the orientation can be determined from an edge. Detection of two intersecting edges will enable determination of both a corner and the orientation. Detection of two corners will determine both position of the sheet and orientation. Of course, processing step 616 typically occurs only after all of the preceding numerical steps have been performed, so that the processing system has all of the information required regarding the coordinates of the registration marks and the sheet corners or edges to translate the job instructions into machine coordinates for processing.

### Material Guide

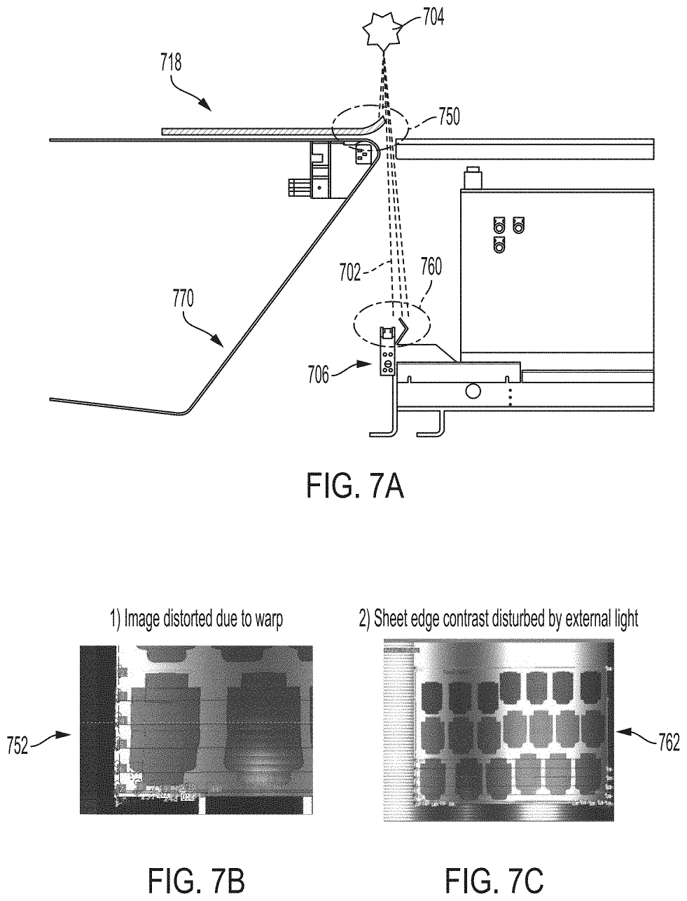

Referring now to FIG. 7A, in certain implementations, sheets 718 to be processed may be susceptible to warping, or system 700 may be deployed in a location in which camera 706 receives unwanted external light 702 from an external light source 704. The impact of a warped edge 750 may cause distortions in the captured image 752, as depicted in the captured image depicted in FIG. 7B. External light 702 passing beyond the edge of the sheet may impinge upon the lens of the camera 706 in region 760, and may create a disturbance in the sheet edge contrast, as depicted in the captured image depicted in FIG. 7C.

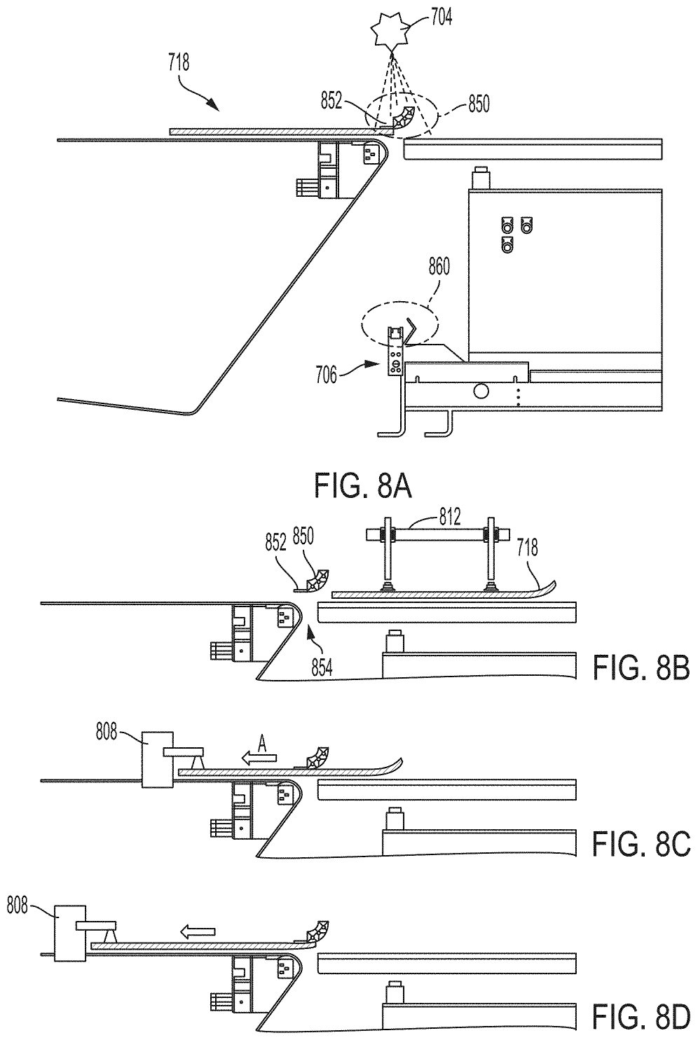

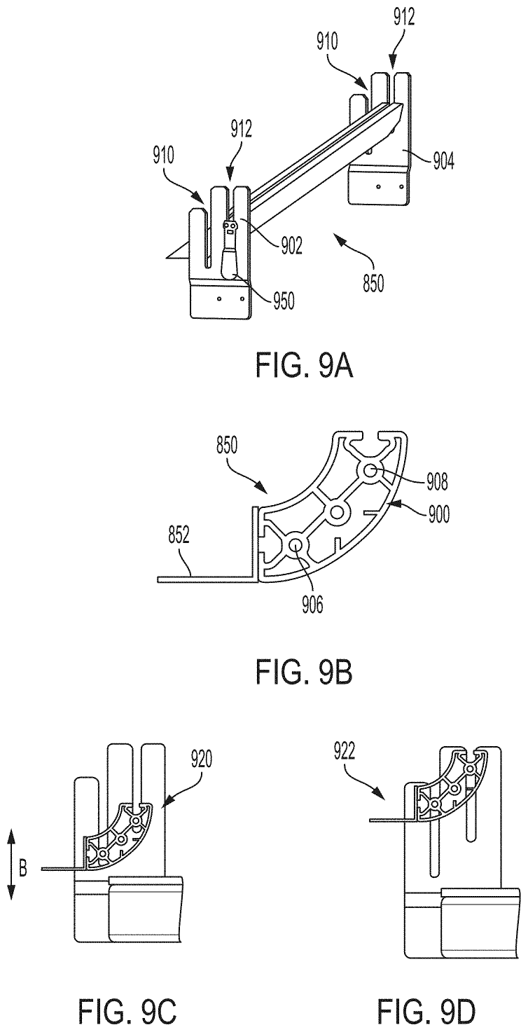

As depicted in FIG. 8A, to alleviate the foregoing problems, it may be desirable to deploy a material guide or anti-warp bar 850, mounted above the gap over which the sheet of media passes, the material guide configured to both hold down the media as it is conveyed through the gap and to prevent external light from being transmitted through the gap. The result is a camera region 860 that is free of external light transmitted through the gap and impinging upon the camera lens. The material guide 850, shown in cross-section in FIG. 9B, has one edge 900 with a rounded, semicircular shape. Although depicted as rounded in the form a quarter-circle in cross-section, the configuration of the leading edge is not limited to any particular geometry, and may comprise an angled, beveled, chamfered, or multi-faceted geometry (i.e. has a geometry with n number of faces in cross-section, where n is greater than or equal to 2, wherein the larger n, the closer the transition is to having a rounded geometry). The “rounded” shape is not necessarily circular, but may conform to any type of curve, including elliptical or parabolic shapes. As shown in FIGS. 8B-8D, material guide 850, and the gap 854, each have a leading edge and a trailing edge relative to the material path A. The material guide is positioned with its rounded side facing the leading edge to gradually urge a vertically raised edge of the sheet in a downward direction as the sheet moves relative to the guide along the material path A. Extension 852 is disposed parallel to the material path on the trailing edge of the material guide and extends the lowest elevation of the material guide downstream, preferably downstream of the trailing edge of the gap, as depicted in FIGS. 8A-8D.

The material guide is preferably positioned with its leading edge upstream of the gap 854 leading edge. The material guide is preferably opaque or at least significantly light-restricting so that in addition to urging the edge of the sheet downward, the material guide also serves as a sufficient light block. The guide preferably spans a distance from sufficiently upstream of the leading edge to sufficiently downstream of the trailing edge of the gap to minimize light entry through the gap toward the camera. Thus, the overall length of the light guide from its leading edge to the trailing edge of the extension preferably blocks light through the entire gap. As shown in FIGS. 8B-8D, other parts of the system may comprise a robotic sheet handler 812 configured to pick up and feed the sheet, and a gantry system 808 (moveable upstream and downstream along the material path), on which may be mounted a topside camera and/or a processing heads (e.g. cutting heads) for processing the sheet. The system downstream of the gap and material guide may comprise a conveyor belt apparatus 770 for moving the sheet into position for further processing.

As depicted in FIGS. 9A, 9C, and 9D, the material guide may be removable and vertically adjustable for accommodating material sheets of different thicknesses to be processed. Although such functionality may take many forms, in one exemplary configuration depicted in FIG. 9A, material guide 850 rests in a pair of slotted brackets 900, 902 mounted on opposite ends of the processing system. A pair of pins on each end in locations 906, 908 align with slots 910, 912, respectively, thereby permitting the guide to translate along arrow B between a relatively lower configuration 920 (shown in FIG. 9C) and a relatively higher configuration 922 (shown in FIG. 9D). The adjustment system includes fasteners to affix the guide at a desired height, such as a pair of cam lever fasteners 950 on at least one pin on each of the opposite sides of the guide, as depicted in FIG. 9A. Implementations are not limited to any particular types of fasteners for affixing the guide at a desired height, nor are the material guide systems limited to any particular mechanisms for providing adjustability and/or removability of the guide. Although material guide is shown as having a lightweight, but stiff cross-section, such as may be manufactured using extruded metal, such as aluminum, or plastic, the guide is not limited to any particular materials of construction or cross-sectional configuration. Constructions that permit maximum strength and minimum deflection at minimal weight are preferred.

Although depicted in the flipside reader system as described herein, it should be understood that a material guide as described above may be useful in any type of processing system in which it may be important to vertically constrain a sheet in a downward direction. Likewise, some sheet media may not be prone to warping and some installations may not have extraneous light, and therefore may have no need for a material guide as described herein.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for processing a sheet with a processing machine configured to perform one or more processes on the sheet from a top side of the sheet, the sheet having printed graphics on a printed underside of the sheet, the method comprising the steps of:
(a) capturing a plurality of images from the printed underside of the sheet, each image representative of a portion of the printed graphics within a field of view of one of a plurality of underside image capture devices;
(b) stitching together the plurality of images to produce a continuous image of the printed underside of the sheet, including one or more registration marks, at least one identification mark, and one or more corners or edges of the sheet;
(c) identifying the sheet or a job associated with the sheet based upon detection of at least one identifying indicia on the printed underside, and retrieving a set of stored processing instructions associated with the detected indicia;
(d) determining locations of the one or more corners of the sheet and locations of the one or more registration marks relative to the one or more corners in table coordinates;
(e) determining actual locations of the printed graphics of the sheet in coordinates of a processing machine;
(f) determining actual locations of the registration marks in coordinates of the processing machine based upon the determinations of steps (d) and (e); and
(g) controlling at least one processing path of the processing machine based upon the locations of the registration marks in processing machine coordinates and the retrieved processing instructions.

2. The method of claim 1, further comprising feeding the sheet to the processing machine from a feeder along a feed path, the feed path having a gap between the feeder and the processing machine through which the printed underside of the sheet is within the field of view of each of the plurality of image capture devices.

3. The method of claim 1, wherein the step of determining the actual location of the printed graphics of the sheet in coordinates of the processing machine comprises capturing an image of edges or corners from a top side of the sheet and correlating it with the continuous image of the printed underside of the sheet.

4. The method of claim 1, wherein the step of identifying the sheet or job associated with the sheet comprises capturing an image of a 2D code on the printed underside of the sheet, processing the image of the code to read the code, and using the code to identify the sheet or the job associated with the sheet.

5. The method of claim 4, wherein the code comprises machine-readable job information embedded in the code.

6. The method of claim 4, wherein the code comprises embedded information that identifies a storage location in computer storage where the job information can be retrieved.

7. The method of claim 1, wherein the processing path of the processing machine comprises a creasing, cutting, or perforating path.

8. A system for processing a sheet having printed graphics on a printed underside of a sheet, the printed graphics comprising at least one sheet identifier and one or more printed registration marks, the system comprising:
a processing machine for processing the sheet from a top side of the sheet;
a feeder for feeding the sheet to the processing machine along a material path, the material path comprising a gap between the feeder and the processing machine through which the underside of the sheet is visible;
a plurality of underside cameras positioned below the gap configured to collectively capture a plurality of images, each camera configured to capture one or more images as the sheet passes over the gap along the feed path, each of the one or more images representative of a portion of the printed graphics within a field of view of one of the plurality of cameras;
a detector configured to detect the at least one sheet identifier;
means for determining location of the one or more corners or edges of the sheet in machine coordinates;
a processor configured to:
(a) stitch together the plurality of images captured by the plurality of underside cameras to produce a continuous image of the printed underside of the sheet, including the one or more printed registration marks and one or more corners or edges of the sheet;
(b) identify the printed sheet, or a job associated with the printed sheet, based upon the detected at least one sheet identifier, and retrieve stored processing instructions associated with the printed sheet or the job;
(c) determine in table coordinates the locations of the one or more corners of the printed sheet and locations of the one or more registration marks relative to the one or more corners; and
(d) calculate at least one path for processing the printed sheet based on the locations of the registration marks relative to the one or more corners and the processing instructions; and
a controller in the processing machine in communication with the processor, the controller configured to execute the processing instructions.

9. The system of claim 8, wherein the means for determining the location of the one or more corners of the sheet in machine coordinates comprises at least one topside camera configured to capture an image of a topside of the sheet.

10. The system of claim 8, wherein the at least one sheet identifier comprises a printed 2D code and the detector comprises a camera positioned to capture an image of the printed 2D code.

11. The system of claim 10, wherein the camera positioned to capture the image of the 2D code is one of the plurality of underside cameras.

12. The system of claim 11, wherein the plurality of underside cameras comprises a first set of at least two cameras configured to capture the image of the one or more printed registration marks and the one or more corners or edges of the sheet, and at least one dedicated camera configured to capture the image of the 2D code, wherein the at least one dedicated camera is not in the first set of at least two cameras.

13. The system of claim 10, wherein the code comprises machine-readable job information embedded in the code.

14. The system of claim 10, further comprising a computer memory accessible to the processor, wherein the code comprises embedded information that identifies a storage location in the computer memory where the job information can be retrieved.

15. The system of claim 8, wherein the processing machine is a finisher configured to create creases, cuts, or perforations in the sheet.

16. The system of claim 8, further comprising a material guide positioned above the material path, the material guide configured to constrain the sheet vertically as it passes over the gap.

17. The system of claim 16, wherein the material guide is further configured and positioned to reduce light emanating from above the material guide from impinging upon the detector.

18. The system of claim 16, wherein the material guide and the gap each have a leading edge and a trailing edge relative to the material path, wherein the material guide leading edge is configured and disposed to gradually urge a vertically raised edge of the sheet in a downward direction as the sheet moves relative to the guide along the material path.

19. The system of claim 18, wherein the material guide tailing edge includes an extension that extends downstream parallel to the material path.

20. The system of claim 18, wherein the leading edge of the material guide of the material guide is disposed upstream of the leading edge of the gap and the trailing edge of the material guide is disposed downstream of the trailing edge of the gap.

21. The system of claim 16, wherein the material guide is removable and vertically adjustable relative to the material path.

22. A computer implemented method for processing a sheet having printed graphics on a printed underside of the sheet, the method comprising the steps of:
(a) capturing, by a plurality of cameras positioned below a gap between a feeder and a processing table traversed by the printed sheet as it moves from the feeder to the processing table, a plurality of images, each image representative of a portion of the printed graphics within a field of view of one of the plurality of cameras;
(b) stitching together, by a computer processor, the plurality of images to produce a continuous image of the printed underside of the sheet, including one or more registration marks, at least one identification mark, and one or more corners or edges of the printed sheet;
(c) identifying, by the computer processor, the printed sheet or a job associated with the printed sheet based upon detection of identifying indicia on the sheet, and determining processing instructions associated with the identifying indicia;
(d) determining, by the computer processor, locations of the one or more corners of the printed sheet and locations of the one or more registration marks relative to the one or more corners in sheet coordinates;
(e) determining, by the computer processor, actual locations of the one or more corners in machine coordinates;
(f) determining, by the computer processor, actual locations of the one or more registration marks in machine coordinates based upon the locations of the one or more corners in machine coordinates and the locations of the one or more registration marks relative to the one or more corners in sheet coordinates;
(g) controlling, by the computer processor, at least one path for processing the printed sheet based upon the locations of the registration marks in machine coordinates and the processing instructions.

23. A system for processing a printed sheet having one or more machine-detectible features located on an underside of the sheet, the system comprising:
a processing machine for processing the sheet;
a feeder for feeding the sheet to the processing machine along a feed path, the feed path comprising a gap between the feeder and the processing machine through which the underside of the sheet is visible;
one or more detectors, including at least one image capture device, positioned underneath the feed path, the at least one image capture device configured to detect the machine-detectible features as the sheet passes through the gap; and
a material guide positioned above the feed path and configured to constrain the sheet vertically as it passes through the gap.
